(19) United States
(12) Patent Application Publication
(10) Pub. No.: US 2007/0113398 A1
(43) Pub. Date: May 24, 2007

(54) Contact-pressing tool

(76) Inventor: Niklas Jonasson, Alvdalen (SE)

Correspondence Address: JACOBSON HOLMAN PLLC, 400 SEVENTH STREET N.W., SUITE 600, WASHINGTON, DC, 20004, US

(21) Appl. No.: 11/318,460

(22) Filed: Dec. 28, 2005

(30) Foreign Application Priority Data
Nov. 24, 2005 (SE) 0502592-9

(51) Int. Cl. H01R 43/042; B23P 19/00; H01B 13/20

(52) U.S. Cl. 29/751; 29/758; 29/761; 29/828

(57) ABSTRACT

A contact-pressing tool for radial contact pressing of a contact piece on an end portion of a cable comprises a cup-shaped part (33), which receives the end of the cable (20), and a gland (31), which surrounds the wall of the cup-shaped part (33) and can be pushed up axially on the same in order to, by wedge action, radially press the wall of the cup-shaped part (33) against the circumference of the cable. The tool comprises two mutually linearly movable clamping jaws (1, 2). A first one (1) of the clamping jaws is a turret (10), which has a plurality of different adapters (40) placed along an arc of a circle centred to the axis (12) of the turret. A releasable locking holds the turret in a set rotary position, for which a chosen adapter (40) is directed toward a slot (7) in the second jaw (2) for the cable (20) premounted to the contact piece (30). The tool has a locking mechanism (6) that guarantees that the clamping jaws (1, 2) assume a predetermined minimum distance, before the clamping jaws (1,2) again can be brought apart. The different adapters (40) are mounted with the respective vertical positions above the turret (10) so that each type of contact piece (30) that fits an appurtenant adapter (40) experiences a correct contact pressing when the clamping jaws (1, 2) assume the minimum distance thereof.

The invention relates to a contact-pressing tool of the kind that is seen in the preamble of claim 1.

In order to by contact pressing (“crimping”) correctly mount a contact piece on an end portion of, for instance, a coaxial cable or similar cable, it is from practice well known to use a contact piece, which has a substantially cup-shaped end portion, the cylindrical circumference wall of which defines a first gland, which receives the end portion of the cable, and a second gland that surrounds the end portion of the first gland and is axially displaceable thereon, at least one of the nearby surfaces of the glands having a wedge surface so that the inner gland is contact pressed plastically around the end portion of the cable and is anchored closely to the same upon the axial bringing together of the glands. Such contact pieces for such a type of contact pressing are well known and are marketed, for instance, under the designations CATV“F”, BNC, RCA and the like, the contact pieces usually being available in two types, namely as male and female, respectively, for mutual co-operation. These contact pieces are intended to be mounted on the corresponding cables.

From practice, it is, in that connection, previously known to mount such contact pieces by means of a tool of manually operated type, i.e., a field-working tool, which has a pair of mutually movable jaws or clamping jaws, which move toward and away from each other and in that connection are parallel. In that connection, the tool has a pair of mutually displaceable handle branches, which via a transmission known per se convert the branch motion into the motion of the jaws. Furthermore, the tool is provided with a locking device of a kind well-known per se, which guarantees that the clamping jaws are brought to a selected mutual minimum distance before the locking is disengaged to allow the branches and the jaws to be brought apart for a another operation.

Each contact piece has a first end in which the cable end is inserted and attached and a second end having a connector such as a male or female contact. A first one of the clamping jaws is arranged to carry an adapter, which fittingly can receive the connector of the contact piece in order to guide and support the contact piece. The opposite tubular end portion of the contact piece is threaded over the end portion of the cable. The second clamping jaw/jaw of the contact-pressing tool has a recess for the cable, so that the contact piece is directed parallel to the mutual direction of motion of the clamping jaws, when the cable is received in the recess. The verge of the recess abuts against the displaceable gland of the contact piece for axial displacement of the same over and around the cup-shaped radially inner gland of the contact piece, which, on that occasion, experiences a symmetrical elastic and/or plastic deformation directed radially inward.

The cable end has usually an insulator casing, the end portion of which is peeled off. A cable shield that possibly is incorporated in the cable and that, on that occasion, is laid bare, may be folded back over the insulator casing in order to produce contact with the inner circumference wall of the gland upon the contact-pressing operation. In that connection, the central conductor of the cable may extend via an insulator bushing in a bottom wall of the gland and axially extend into the contact for the contact with a corresponding female contact on a connecting contact piece.

The contact piece may be provided with a first part of a coupling joint, for instance in the form of an internally threaded nut sleeve, which is turnably mounted on the contact piece for the engagement with a second coupling-joint part in the form of an external thread on a contact piece co-operating therewith.

The adapter and the recess are aligned along a line that is parallel to the mutual direction of motion of the clamping jaws, and the contact and the cable are premounted and put in place on the adapter and in the recess, respectively, so that the contact piece is oriented parallel to the mutual direction of displacement of the clamping jaws, the second clamping jaw being positioned near the free end of the displaceable gland of the contact piece.

The contact-pressing tool may now be driven, whereby the gland of the contact piece is pressed down over the fixed cup part of the contact piece, in which the cable end is received, whereby said contact pressing is established.

Of course, the contact-pressing tool should be able to be used for a plurality of different types of contact pieces. It is, in that connection, previously known to provide a group of adapters, i.e., one adapter for each type of connector in question for the different contact pieces in question. A problem is that the operator has to dismount a previously used adapter from the contact-pressing tool and mount the adapter in question on the clamping jaw in question of the contact-pressing tool in a relatively complicated operation, each time another type of contact piece should be contact pressed on a cable.

In that connection, a problem is that the operator easily may loose one or more of these different adapters in a set of adapters, between the occasions of use.

An additional problem is that, if the tool is provided with an adapter that after remounting can co-operate with a male and female variant, respectively, of the type of contact piece in question, usually an adjustment of the distance of the adapter from the opposite clamping jaw is required upon the corresponding adaptation of the contact-pressing tool.

Therefore, an object of the invention is to provide a contact-pressing tool by means of which one or more of the mentioned drawbacks are obviated entirely or partly.

The object is attained by the invention.

The invention is defined in the appended independent claim.

Embodiments of the invention are defined in the appended dependent claims.

By mounting a plurality of adapters on a turret, the axis of rotation of which is parallel to the mutual direction of motion of the clamping jaws, with centring along an arc of a circle, the centre of which is positioned in the axis of rotation of the turret, the effect is attained that the turret, as rotatably mounted on one of the clamping jaws of the tool, readily can carry a great number of adapters, and that the adapters readily can be inserted into the correct position, just opposite the second clamping jaw of the tool, the adapters being carried at mutually adapted distances over the turret, in such a way that the adapters always get correct mutual distances to the opposite clamping jaw, whereby the contact-pressing tool immediately can be used as soon as the adapter in question of the turret has been driven into operative position. In preferred embodiments, the turret is releasably lockable in correct positions for the respective adapter by means of a releasable locking device, for instance of the type spring-loaded bullet, which engages into an appurtenant countersink in an opposite tool part. Furthermore, the turret may, for instance on the bottom side, have different markings distributed around the circumference, which when they are directed toward a reference, indicate that a corresponding adapter is in working position.

In the following, the invention will be described by way of examples, reference being made to the appended drawing.

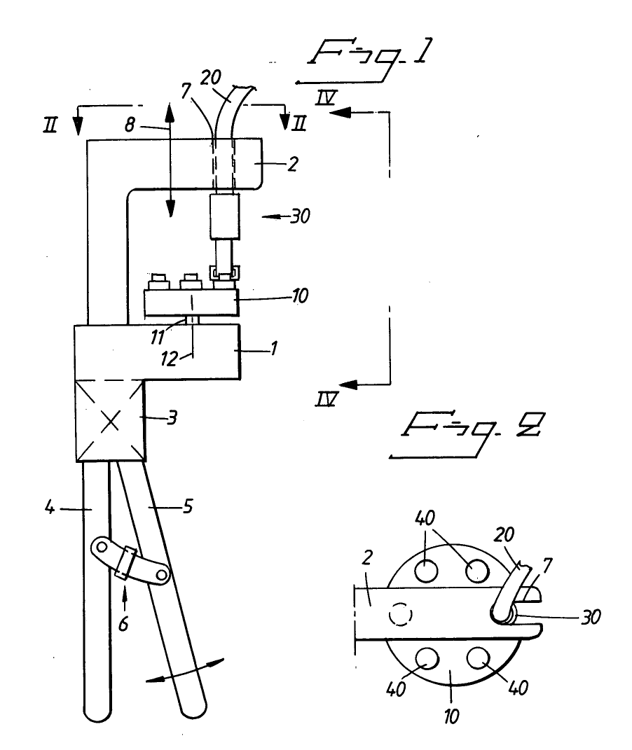

FIG. 1 shows a schematic side view of a contact-pressing tool.

FIG. 2 shows a schematic view taken along line II-II in FIG. 1.

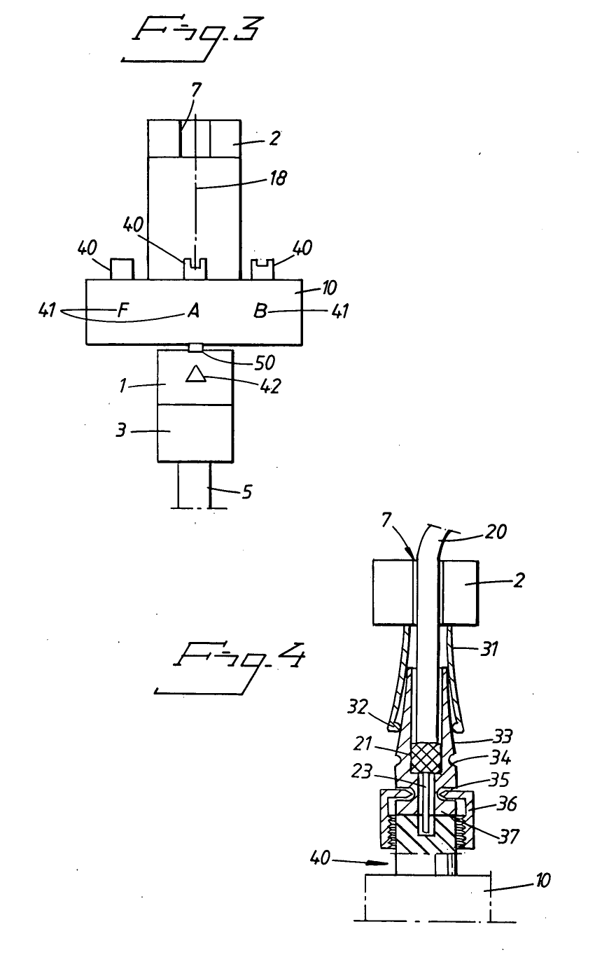

FIG. 3 shows a schematic view taken along line IV-IV in FIG. 1.

FIG. 4 shows in a part view corresponding to FIG. 3 an axially cut contact piece inserted in the tool, which contact piece is to be contact pressed on an end part of a cable inserted therein.

In FIG. 1, a manually operable contact-pressing tool is shown for the contact pressing (crimping) of a contact piece 30 on an end part of a cable 20, for instance, a coaxial cable. The tool comprises two mutually parallel clamping jaws 1, 2, which are mutually linearly movable in a direction that is parallel to the axis of the contact piece 30, when the contact piece 30 is correctly mounted in the tool.

The tool is shown to be of a manually operable kind and includes two handle branches 4, 5, which are mutually turnable and drive a transmission 3, which creates the motion of the clamping jaws 1, 2 to and from each other. The transmission 3 is of a known kind per se. Between the handle branches 4, 5, a locking mechanism 6 is shown, which when the branches 4, 5 assume a brought-together adjustable end position, which corresponds to a minimum distance between the clamping jaws 1, 2, disengages the branches 4, 5 for mutual turning away from each other so that the clamping jaws 1, 2 go apart.

One of the clamping jaws 1 is shown to carry a turret 10, which is rotary mounted around an axis 12, which is parallel to the mutual direction of displacement of the jaws 1, 2. For instance, the turret 10 may have a journal 11, which is mounted in an appurtenant bearing mounting in the clamping jaw 1.

On the side of the turret 10 that is facing the clamping jaw 2, there is a number of adapters 40 mounted. The adapters 40 are positioned centred on an arc of a circle, the centre of which coincides with the axis 12.

A releasable locking device 50, for instance of the type spring-loaded bullet on the clamping jaw 1, and a respective recess in the turret 10 co-operating with the bullet allows the respective appurtenant adapter 40 to be locked in the working position thereof. In that connection, the free end part of the contact piece 30 can be received on the adapter 40 in the working position and the cable part 20 connecting to the contact piece 30 can lie received in a slot 7 in the clamping jaw 2, in such a way that the contact piece 30 has the axial direction 18 thereof parallel to the mutual direction of motion 8 of the clamping jaws 1, 2. Different adapters 40 are spaced-apart around the turret. The adapters 40 have an adjusted vertical position so that each type of contact piece 30 that fits an appurtenant adapter 40 is fully contact pressed on the end of the cable 20, when the jaws 1, 2 have assumed a mutual minimum distance, such as defined by the adjustable supporting mechanism 6.

FIG. 3 illustrates that the turret 10 has markings 41 distributed around the circumference, each one of which is associated with an appurtenant adapter, which is in working position when the corresponding marking is positioned directed toward a reference, such as the symmetry plane of the jaw 1 or, as is shown, an indicator 42, and when the releasable locking device 50 has come into engagement.

From FIG. 4, it can be understood that the contact piece 30 comprises a cup-shaped part 33, which receives the end portion of a cable 20, for instance, a coaxial cable, the shield 21 of which is shown folded back over the outer cover of the cable for contact with the wall of the cup-shaped part in the bottom portion thereof. The bottom of the cup-shaped part has an opening having a hollow-cylindrical insulator, the centre conductor 23 of the coaxial cable extending through the insulator and projecting underneath the bottom 37 of the cup-shaped part 33. On the cup-shaped part 33, there is an externally overlapping gland 31. The gland 31 is displaceable on the wall of the cup part 33. The co-operating wall surfaces on the cup part 33 and the gland 31 are wedge-shaped so that the wall of the cup part 33 is plastically or elastically deformed radially by the gland 31, when the same is pushed down into an end position in which a bulge 32 on the gland can snap into an appurtenant recess 34 at the lower circumference portion of the cup part 33. In that connection, the jaws 1, 2 are at the minimum distance thereof defined by the locking device.

The bulge may be formed by a ring, for instance of plastic, which is mounted on the gland 31.

In FIG. 4, the bottom portion of the cup part 33 is shown to have a circumference groove 35, which receives a waist rim of a nut 36, which thus is rotatable on the cup part 33. The adapter 40 in question of the turret 10 is shown received in the nut 36 and rests against the bottom surface 37 of the cup part. The adapter 40 has such a height above the turret 10 that the bringing together of the parts of the contact piece 30 precisely is attained when the clamping jaws 1, 2 assume the mutual minimum distance thereof.

If, for instance, a corresponding contact piece 30 of female type is to be mounted on a cable end 20, naturally another appurtenant type of adapter 40 is required for stable concentric support of an end of the contact piece provided with external thread.

An operator who is to mount any of a plurality of different contact pieces 30 on the end of a cable 20, may accordingly premount the contact piece 30 in question on the end of the cable 20, and rotate the turret 10 so that the corresponding adapter 40 is brought into correct working position, after which the contact piece is introduced such as is shown in FIG. 1 in order to closely be crimped around the circumference of the cable and be anchored to the cable.

1. Contact-pressing tool comprising a pair of mutually movable clamping jaws, which are arranged to move toward and away from each other, the tool having a pair of mutually displaceable handle branches (4, 5), which via a transmission (3) convert the turning motion into said linear motion of the jaws, a locking device (6), which guarantees that the clamping jaws are brought to a selected mutual minimum distance before the locking is disengaged to allow the handle branches (4, 5) and the clamping jaws to be brought apart for a another operation, a first one of the clamping jaws being arranged to carry an adapter (40), which fittingly can receive a connector (23, 36, 37) of a contact piece of a contact (30) that is premounted on an end portion of a cable (20), the second clamping jaw having a slot that receives the cable and can act on the end of the contact piece opposite the connector, so that the contact piece is directed axially parallel to the mutual direction of motion of the clamping jaws, the contact piece comprising a cup-shaped part that receives the end portion of the cable, and a gland (31) that surrounds the cup-shaped part (33) and can be pressed up axially on the same for radial compression of the wall of the cup-shaped part against the cable for tight connection with the same, characterized in that the first clamping jaw (1) carries a turret (10) for rotation around an axis (12), the turret (10) carrying a plurality of different adapters (40) that are arranged on an arc of a circle centred to the axis of rotation (12) of the turret, the turret being rotatable into rotary positions, in which the respective adapter (40) is positioned directed in working position for the support of an appurtenant contact piece (30).

2. Contact-pressing tool according to claim 1, characterized in that each adapter (40) is located at a height above the turret (10), for which the appurtenant contact piece (30) experiences a predetermined axial bringing together of the parts (31, 33) thereof, when the clamping jaws (1, 2) assume the minimum distance thereof defined by the locking device (6).

3. Contact-pressing tool according to claim 1, characterized in that a releasable locking device (50) is arranged to rotationally lock the turret (10) in the working position of the respective adapter.

4. Contact-pressing tool according to claim 2, characterized in that a releasable locking device (50) is arranged to rotationally lock the turret (10) in the working position of the respective adapter.
